(19) United States
(12) Patent Application Publication
(10) Pub. No.: US 2016/0251735 A1
(43) Pub. Date: Sep. 1, 2016

(54) METHODS AND COMPOSITIONS FOR DECREASING ADHERENCE OF IRON OXIDE PELLETS USED IN DIRECT REDUCTION PROCESSES

(71) Applicant: SAUDI BASIC INDUSTRIES CORPORATION, Riyadh (SA)

(72) Inventors: Mohamed Bahgat Saddik, Riyadh (SA); Syed Niaz Ahsan, Riyadh (SA)

(21) Appl. No.: 15/027,857

(22) PCT Filed: Nov. 4, 2014
(86) PCT No.: PCT/IB2014/065795

§ 371 Date: Apr. 7, 2016

Related U.S. Application Data
(60) Provisional application No. 61/900,257, filed on Nov. 5, 2013.

(51) Int. Cl. C21B 13/00; C04B 28/04; C04B 14/30; C21B 13/02

(52) U.S. Cl. CPC C21B 13/008; C21B 13/02; C04B 28/04; C04B 14/308

(57) ABSTRACT

Disclosed herein are methods and compositions for producing coated iron oxide pellets comprising an outer coating comprising cement exhibiting a reduced sticking index while retaining a high level of metallization following reduction. The improved coated iron oxide pellets can be used to produce direct reduced iron (DRI) with improved productivity.

### CROSS-REFERENCE TO RELATED APPLICATIONS

This Application claims the benefit of and priority to U.S. Provisional Application No. 61/900,257, filed on Nov. 5, 2013, which is incorporated herein by reference in its entirety.

### FIELD OF INVENTION

The present invention relates to methods and compositions for reducing stickiness of iron oxide pellets having a cement coating for use in direct reduced (DR) processes.

### BACKGROUND OF THE INVENTION

In the moving-bed shaft direct reduction processes, such as Midrex and HYL III, the avoidance of sticking is important. The tendency to stick imposes an upper limit on the reduction temperature and, hence, on the productivity of the process. In the DR (direct reduction) processes, the product is freshly reduced iron in a solid state. It is, therefore, imperative that the material flow in the reducing module does not form aggregates, blocking the material flow within and out of the reactor. If pellets have little or no tendency to stick, the reduction temperature and thus, throughput, can be increased. It has been reported that an increase of 100° C. in the reduction temperature can bring about a significant increase in throughput. High reduction temperature is also essential to minimize degradation and re-oxidation of reduced product, which is an important factor placing additional emphasis on the sticking behavior of pellets. However, decreasing the reducing temperature to avoid this problem can cause a significant drop in throughput. For example, a decrease from 850 to 750° C. can result in a decrease of up to 30-40% in throughput.

Results from past investigations suggest that sticking is a result of the growth of fibrous iron precipitates (iron whiskers) that become hooked to each other and ultimately become crystallized during the initial stages of metallization. One potential way of preventing the sintering between pellets is therefore to keep the iron surfaces of individual pellets apart.

Accordingly, there remains a need for DR methods and materials that can provide reduced clustering of direct reduced iron in DR shaft, while maintaining or increasing productivity. This need and other needs are satisfied by the various aspects of the present disclosure.

### SUMMARY OF THE INVENTION

In accordance with the purposes of the invention, as embodied and broadly described herein, the invention relates to a direct reduction process. The process generally comprises the steps of: a) providing a cement mixture comprising cement; b) applying the cement mixture to one or more iron oxide pellets to provide a coated iron oxide pellet; c) introducing the coated iron oxide pellet to a vertical furnace; and d) reducing the coated iron oxide pellet. Accoreding to aspects, the coated particle exhibits a reduced sticking index that is capable of decreasing the sticking or adherence of the iron oxide pellets during the direct reduction process. For example, the coated iron oxide pellet can exhibit a sticking index that is less than or equal to about 5%. Still further, the metallization of the iron oxide pellet after reduction in the vertical furnace can be at least about 92%.

In a still further exemplary aspect, the invention relates to a coated iron oxide pellet comprising a cement coating.

In further aspects, the invention also relates to articles comprising the disclosed coated iron oxide pellets and direct reduced iron made using the disclosed coated iron oxide pellets and methods.

Additional aspects of the invention will be set forth in part in the description which follows, and in part will be obvious from the description, or can be learned by practice of the invention. The advantages of the invention will be realized and attained by means of the elements and combinations particularly pointed out in the appended claims. It is to be understood that both the foregoing general description and the following detailed description are exemplary and explanatory only and are not restrictive of the invention, as claimed.

### DETAILED DESCRIPTION OF THE INVENTION

The present invention can be understood more readily by reference to the following detailed description of the invention and the Examples included therein.

Before the present compounds, compositions, articles, systems, devices, and/or methods are disclosed and described, it is to be understood that they are not limited to specific synthetic methods unless otherwise specified, or to particular reagents unless otherwise specified, as such can, of course, vary. It is also to be understood that the terminology used herein is for the purpose of describing particular aspects only and is not intended to be limiting. Although any methods and materials similar or equivalent to those described herein can be used in the practice or testing of the present invention, example methods and materials are now described.

Moreover, it is to be understood that unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect. This holds for any possible non-express basis for interpretation, including matters of logic with respect to arrangement of steps or operational flow; plain meaning derived from grammatical organization or punctuation; and the number or type of aspects described in the specification.

All publications mentioned herein are incorporated herein by reference to disclose and describe the methods and/or materials in connection with which the publications are cited.

### A. DEFINITIONS

It is also to be understood that the terminology used herein is for the purpose of describing particular aspects only and is not intended to be limiting. As used in the specification and in the claims, the term “comprising” can include the aspects “consisting of” and “consisting essentially of.” Unless defined otherwise, all technical and scientific terms used herein have the same meaning as commonly understood by one of ordinary skill in the art to which this invention belongs. In this specification and in the claims which follow, reference will be made to a number of terms which shall be defined herein.

As used in the specification and the appended claims, the singular forms “a,” “an” and “the” include plural referents unless the context clearly dictates otherwise. Thus, for example, reference to “a cement composition” includes mixtures of two or more cement compositions.

As used herein, the term “combination” is inclusive of blends, mixtures, alloys, reaction products, and the like.

Ranges can be expressed herein as from one particular value, and/or to another particular value. When such a range is expressed, another aspect includes from the one particular value and/or to the other particular value. Similarly, when values are expressed as approximations, by use of the antecedent ‘about,’ it will be understood that the particular value forms another aspect. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. It is also understood that each unit between two particular units are also disclosed. For example, if 10 and 15 are disclosed, then 11, 12, 13, and 14 are also disclosed.

As used herein, the terms “about” and “at or about” mean that the amount or value in question can be the value designated some other value approximately or about the same. It is generally understood, as used herein, that it is the nominal value indicated ±10% variation unless otherwise indicated or inferred. The term is intended to convey that similar values promote equivalent results or effects recited in the claims. That is, it is understood that amounts, sizes, formulations, parameters, and other quantities and characteristics are not and need not be exact, but can be approximate and/or larger or smaller, as desired, reflecting tolerances, conversion factors, rounding off, measurement error and the like, and other factors known to those of skill in the art. In general, an amount, size, formulation, parameter or other quantity or characteristic is “about” or “approximate” whether or not expressly stated to be such. It is understood that where “about” is used before a quantitative value, the parameter also includes the specific quantitative value itself, unless specifically stated otherwise.

The terms “first,” “second,” “first part,” “second part,” and the like, where used herein, do not denote any order, quantity, or importance, and are used to distinguish one element from another, unless specifically stated otherwise.

As used herein, the terms “optional” or “optionally” means that the subsequently described event or circumstance can or cannot occur, and that the description includes instances where said event or circumstance occurs and instances where it does not. For example, the phrase “optionally substituted alkyl” means that the alkyl group can or cannot be substituted and that the description includes both substituted and unsubstituted alkyl groups.

As used herein, the term or phrase “cement” refers to a composition or substance with one or more constituents that is capable of forming cement or binding materials together, once set. Generally, cement can include a number of dry constituents chosen based on the desired ratio or class of cement to be produced. Thus, cement refers to the dry, pre-set composition unless the context clearly dictates otherwise.

Moreover, it is to be understood that unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect. This holds for any possible non-express basis for interpretation, including matters of logic with respect to arrangement of steps or operational flow; plain meaning derived from grammatical organization or punctuation; and the number or type of aspects described in the specification.

Disclosed are the components to be used to prepare the compositions of the invention as well as the compositions themselves to be used within the methods disclosed herein. These and other materials are disclosed herein, and it is understood that when combinations, subsets, interactions, groups, etc. of these materials are disclosed that while specific reference of each various individual and collective combinations and permutation of these compounds cannot be explicitly disclosed, each is specifically contemplated and described herein. For example, if a particular compound is disclosed and discussed and a number of modifications that can be made to a number of molecules including the compounds are discussed, specifically contemplated is each and every combination and permutation of the compound and the modifications that are possible unless specifically indicated to the contrary. Thus, if a class of molecules A, B, and C are disclosed as well as a class of molecules D, E, and F and an example of a combination molecule, A-D is disclosed, then even if each is not individually recited each is individually and collectively contemplated meaning combinations, A-E, A-F, B-D, B-E, B-F, C-D, C-E, and C-F are considered disclosed. Likewise, any subset or combination of these is also disclosed. Thus, for example, the sub-group of A-E, B-F, and C-E would be considered disclosed. This concept applies to all aspects of this application including, but not limited to, steps in methods of making and using the compositions of the invention. Thus, if there are a variety of additional steps that can be performed it is understood that each of these additional steps can be performed with any specific aspect or combination of aspects of the methods of the invention.

References in the specification and concluding claims to parts by weight, of a particular element or component in a composition or article, denotes the weight relationship between the element or component and any other elements or components in the composition or article for which a part by weight is expressed. Thus, in a compound containing 2 parts by weight of component X and 5 parts by weight component Y, X and Y are present at a weight ratio of 2:5, and are present in such ratio regardless of whether additional components are contained in the compound.

A weight percent (“wt %”) of a component, unless specifically stated to the contrary, is based on the total weight of the formulation or composition in which the component is included. For example if a particular element or component in a composition or article is said to have 8 wt %, it is understood that this percentage is relative to a total compositional percentage of 100wt %.

As used herein, the term or phrase “effective,” “effective amount,” or “conditions effective to” refers to such amount or condition that is capable of performing the function or property for which an effective amount is expressed. As will be pointed out below, the exact amount or particular condition required will vary from one aspect to another, depending on recognized variables such as the materials employed and the processing conditions observed. Thus, it is not always possible to specify an exact “effective amount” or “condition effective to.” However, it should be understood that an appropriate effective amount will be readily determined by one of ordinary skill in the art using only routine experimentation.

Compounds are described using standard nomenclature. For example, any position not substituted by any indicated group is understood to have its valence filled by a bond as indicated, or a hydrogen atom. A dash (“—”) that is not between two letters or symbols is used to indicate a point of attachment for a substituent. For example, —CHO is attached through carbon of the carbonyl group. Unless defined otherwise, technical and scientific terms used herein have the same meaning as is commonly understood by one of skill in the art to which this invention belongs.

Each of the materials disclosed herein are either commercially available and/or the methods for the production thereof are known to those of skill in the art.

It is understood that the compositions disclosed herein have certain functions. Disclosed herein are certain structural requirements for performing the disclosed functions, and it is understood that there are a variety of structures that can perform the same function that are related to the disclosed structures, and that these structures will typically achieve the same result.

### B. IRON OXIDE PELLETS WITH DECREASED ADHERANCE

As briefly described above, the present disclosure relates, in one aspect, to a coated iron oxide pellet for use in a direct reduction (DR) process. As summarized above, the coated iron oxide pellet can exhibit a reduced sticking during a DR process. In one aspect, the coated iron oxide pellet comprises an outer coating. In a further aspect, the coated iron oxide pellet generally comprises an inner core comprising iron oxide and an outer coating comprising cement. In various further aspects, the coated iron oxide pellet comprises iron oxide, silicon oxide, calcium oxide, magnesium oxide, aluminum oxide, carbon, and sulfur.

In various aspects, the coated iron oxide pellet can have any desired shape. In one aspect, the coated iron oxide pellet is in the shape of a sphere or a ball. In a further aspect, the coated iron oxide pellet is formed without any cluster formation.

In a further aspect, the iron oxide comprises hematite (Fe₂O₃; iron (III) oxide), magnetite (Fe₃O₄; triiron tetroxide), limonite (FeO(OH).n(H₂O); hydrated iron (III) oxide hydroxide), siderite (FeCO₃; iron (II) carbonate), iron pyrite (FeS₂; iron (II) disulfide), goethite (FeO(OH); iron (III) oxide hydroxide), or combinations thereof.

In one aspect, the coated iron oxide pellet comprises comprises iron in an amount ranging from 66.0 wt % to 69.0 wt %, based on the total weight of the coated iron oxide pellet, including exemplary values of 66.5 wt %, 67.0 wt %, 67.5 wt %, 68 wt %, and 68.5 wt %. In still further aspects, the coated iron oxide pellet can comprise iron in a range derived from any two of the above listed exemplary values.

In one aspect, the coated iron oxide pellet comprises carbon in an amount ranging from greater than 0 wt % to 0.1 wt %, based on the total weight of the coated iron oxide pellet, including exemplary values 0.02, 0.04, 0.06, and 0.08 wt %.

In one aspect, the inner core comprises iron in an amount ranging from 66.0 wt % to 69.0 wt %, based on the total weight of the inner core, including exemplary values of 66.5 wt %, 67.0 wt %, 67.5 wt %, 68 wt %, and 68.5 wt %. In still further aspects, the coated iron oxide pellet can comprise iron in a range derived from any two of the above listed exemplary values.

In various aspects, the coating comprises cement. The cement can be present in a ratio from about 0.5 kg to about 1.0 kg cement per ton uncoated iron oxide pellets. In a still further aspect, the cement is present in a ratio from about 0.6 kg to about 1.0 kg cement per ton uncoated iron oxide pellets. In a yet further aspect, the cement is present in a ratio from about 0.7 kg to about 1.0 kg cement per ton uncoated iron oxide pellets. In an even further aspect, the cement is present in a ratio from about 0.8 kg to about 1.0 kg cement per ton uncoated iron oxide pellets. In a still further aspect, the cement is present in a ratio from about 0.9 kg to about 1.0 kg cement per ton uncoated iron oxide pellets. In a yet further aspect, the cement is present in a ratio from about 0.5 kg to about 0.9 kg cement per ton uncoated iron oxide pellets. In an even further aspect, the cement is present in a ratio from about 0.5 kg to about 0.8 kg cement per ton uncoated iron oxide pellets. In a still further aspect, the cement is present in a ratio from about 0.5 kg to about 0.7 kg cement per ton uncoated iron oxide pellets. In a yet further aspect, the cement is present in a ratio from about 0.5 kg to about 0.6 kg cement per ton uncoated iron oxide pellets.

In a further aspect, the cement is present in a ratio from about 0.4 kg to about 1.0 kg cement per ton uncoated iron oxide pellets. In a yet further aspect, the cement is present in a ratio from about 0.4 kg to about 0.9 kg cement per ton uncoated iron oxide pellets. In an even further aspect, the cement is present in a ratio from about 0.4 kg to about 0.8 kg cement per ton uncoated iron oxide pellets. In a still further aspect, the cement is present in a ratio from about 0.4 kg to about 0.7 kg cement per ton uncoated iron oxide pellets. In a yet further aspect, the cement is present in a ratio from about 0.4 kg to about 0.6 kg cement per ton uncoated iron oxide pellets.

In a further aspect, the cement is present in a ratio of at least about 0.5 kg cement per ton uncoated iron oxide pellets, for example, at least about 0.6, 0.7, 0.8, or 0.9 kg cement per ton uncoated iron oxide pellets. In a yet further aspect, the cement is present in a ratio of about 0.50, 0.51, 0.52, 0.53, 0.54, 0.55, 0.56, 0.57, 0.58, or 0.59 kg cement per ton of uncoated iron oxide pellets. In an even further aspect, the cement is present in a ratio of about 0.60, 0.61, 0.62, 0.63, 0.64, 0.65, 0.66, 0.67, 0.68, or 0.69 kg cement per ton of uncoated iron oxide pellets. In a still further aspect, the cement is present in a ratio of about 0.70, 0.71, 0.72, 0.73, 0.74, 0.75, 0.76, 0.77, 0.78, or 0.79 kg cement per ton of uncoated iron oxide pellets. Ina yet further aspect, the cement is present in a ratio of about 0.80, 0.81, 0.82, 0.83, 0.84, 0.85, 0.86, 0.87, 0.88, or 0.89 kg cement per ton of uncoated iron oxide pellets. In an even further aspect, the cement is present in a ratio of about 0.90, 0.91, 0.92, 0.93, 0.94, 0.95, 0.96, 0.97, 0.98, or 0.99 kg cement per ton of uncoated iron oxide pellets.

In a further aspect, the cement is present in a ratio of at least about 0.4 kg cement per ton uncoated iron oxide pellets, for example, at least about 0.5, 0.6, 0.7, 0.8, or 0.9 kg cement per ton uncoated iron oxide pellets. In a yet further aspect, the cement is present in a ratio of about 0.40, 0.41, 0.42, 0.43, 0.44, 0.45, 0.46, 0.47, 0.48, 0.49, or 0.50 kg cement per ton of uncoated iron oxide pellets.

In various aspects, the coating can further optionally comprise one or more additional components. In one aspect, the cement further comprises an aggregate component. In a further aspect, the aggregate component comprises sand, gravel, limestone, granite, marble, or stone, or a combination thereof. In a still further aspect, the aggregate component comprises fine aggregate or course aggregate, or a combination thereof. In this aspect, the aggregate can have various particle sizes and distributions.

In various aspects, the coating can optionally comprise at least one additional chemical component. In a further aspect, the chemical component comprises an accelerator, a retarder, a plasticizer, a superplasticizer, a pigment, a corrosion inhibitor, a bonding agent, or a pumping agent, or a combination thereof.

In one aspect, the compisite iron oxide pellet can have any desired average pellet size. In a further aspect, the average pellet size can range from about 10 mm to 15 mm, including exemplary values of 10 mm, 11 mm, 12 mm, 13 mm and 14 mm. In a still further aspect, the average pellet size can be in a range derived from any two of the above listed exemplary values. For example, the average pellet size can range from 11 mm to 13 mm.

In various aspects, the coated iron oxide pellet exhibits at least one improved property. For example, the coated iron oxide pellet can exhibit an improved physical, mechanical, chemical, or metallurgical property, or any combination thereof.

In one aspect, the coated iron oxide pellets exhibit a sticking index of less than or equal to 5.0%, inlcuding exemplary values of 4.7, 4.5, 4.3, 4.0, 3.7, 3.5, 3.3, and 3.0%. In a further aspect, the sticking index can be in a range derived from any two of the above listed exemplary values. For example, the sticking index can range from 3.0% to 5.0%.

### C. METHODS OF MAKING THE COATED IRON OXIDE PELLETS

Also disclosed herein are methods of making the coated iron oxide pellets described above. In one aspect, the invention provides a method for preparing a coated iron oxide pellet. The method generally comprises: a) forming a cement mixture; b) applying the cement mixture to iron oxide pellet to provide a coated iron oxide pellet; and c) drying the coated iron oxide pellet. In a further aspect, the method further comprises introducing the coated iron oxide pellet to a vertical furnace, and reducing the coated iron oxide pellet. In some aspects, the cement mixture further comprises a binder.

In one aspect, the cement mixture comprises cement and water, e.g., a cement-water slurry. In a further aspect, the cement mixture can further optionally comprise one or more additional components. Thus, according to various aspects of invention, the cement mixture further comprises an aggregate component. In a further aspect, the aggregate component comprises sand, gravel, limestone, granite, marble, or stone, or a combination thereof. In a still further aspect, the aggregate component comprises fine aggregate or course aggregate, or a combination thereof. In this aspect, the aggregate can have various particle sizes and distributions. In a still further aspect, the coating can optionally comprise at least one additional chemical component. In a further aspect, the chemical component is an accelerator, a retarder, a plasticizer, a superplasticizer, a pigment, a corrosion inhibitor, a bonding agent, or a pumping agent, or a combination thereof.

In an exemplary aspect, the cement mixture comprises from about 12 wt % to about 22 wt % cement. In a yet further aspect, the cement mixture comprises from about 12 wt % to about 21 wt % cement. In a still further aspect, the cement mixture comprises from about 12 wt % to about 20 wt % cement.

In a yet further exemplary aspect, the cement mixture comprises from about 18 wt % to about 20 wt % cement. In a still further aspect, the cement mixture comprises from about 18 wt % to about 21 wt % cement. In a still further aspect, the cement mixture comprises from about 18 wt % to about 22 wt % cement.

It is to be understood that the combined weight percent value of all components does not exceed about 100 wt % and all weight percent values are based on the total weight of the composition, such as for example the total weight of the cement mixture composition. Thus, if an exemplary cement mixture is described as having from about 18 wt % to about 22 wt % cement, the balance of the wt % of the composition, less any optional additional components, can be water.

In various aspects, the cement mixture comprises cement in an amount ranging from 12 wt % to about 20 wt %, based on the total weight of the cement mixture, including exemplary values, 13 wt %, 14 wt %, 15 wt %, 16 wt %, 17 wt %, 18 wt %, and 19 wt %. In a still further aspect, the cement mixture comprises cement in an amount within any range derived from the above values. For example, the cement can be present in the cement mixture in an amount ranging from 13 wt % to 20 wt %, based on the total weight of the cement mixture. In a yet further aspect, the cement mixture comprises cement in an amount ranging from 14 wt % to 20 wt %, based on the total weight of the cement mixture. In an even further aspect, the cement mixture comprises cement in an amount ranging from 15 wt % to 20 wt %, based on the total weight of the cement mixture. In a still further aspect, the cement mixture comprises cement in an amount ranging from 16 wt % to 20 wt %, based on the total weight of the cement mixture. In a yet further aspect, the cement mixture comprises cement in an amount ranging from 17 wt % to 20 wt %, based on the total weight of the cement mixture. In an even further aspect, the cement mixture comprises cement in an amount ranging from 18 wt % to 20 wt %, based on the total weight of the cement mixture. In a still further aspect, the cement mixture comprises cement in an amount ranging from 19 wt % to 20 wt %, based on the total weight of the cement mixture.

For example, in a further aspect, the cement mixture comprises cement in an amount ranging from 12 wt % to 19 wt %, based on the total weight of the cement mixture. In an even further aspect, the cement mixture comprises cement in an amount ranging from 12 wt % to 18 wt %, based on the total weight of the cement mixture. In a still further aspect, the cement mixture comprises cement in an amount ranging from 12 wt % to 17 wt %, based on the total weight of the coating. In an even further aspect, the coating comprises cement in an amount ranging from 12 wt % to 16 wt %, based on the total weight of the cement mixture. In a still further aspect, the cement mixture comprises cement in an amount ranging from 12 wt % to 15 wt %, based on the total weight of the cement mixture. In a yet further aspect, the coating comprises cement in an amount ranging from 12 wt % to 14 wt %, based on the total weight of the cement mixture. In an even further aspect, the cement mixture comprises cement in an amount ranging from 12 wt % to 13 wt %, based on the total weight of the cement mixture.

In various aspects, the cement mixture comprises cement in an amount ranging from 12 wt % to about 21 wt %, based on the total weight of the cement mixture, including exemplary values, 13 wt %, 14 wt %, 15 wt %, 16 wt %, 17 wt %, 18 wt %, 19 wt %, and 20 wt %. In a still further aspect, the cement mixture comprises cement in an amount within any range derived from the above values. For example, the cement mixture comprises cement in an amount ranging from 13 wt % to 21 wt %, based on the total weight of the cement mixture. In a yet further aspect, the cement mixture comprises cement in an amount ranging from 14 wt % to 21 wt %, based on the total weight of the cement mixture. In an even further aspect, the cement mixture comprises cement in an amount ranging from 15 wt % to 21 wt %, based on the total weight of the cement mixture. In a still further aspect, the coating comprises cement mixture in an amount ranging from 16 wt % to 21 wt %, based on the total weight of the cement mixture. In a yet further aspect, the cement mixture comprises cement in an amount ranging from 17 wt % to 21 wt %, based on the total weight of the cement mixture. In an even further aspect, the cement mixture comprises cement in an amount ranging from 18 wt % to 21 wt %, based on the total weight of the cement mixture. In a still further aspect, the cement mixture comprises cement in an amount ranging from 19 wt % to 21 wt %, based on the total weight of the cement mixture. In a yet further aspect, the cement mixture comprises cement in an amount ranging from 19.5 wt % to 20.5 wt %, based on the total weight of the cement mixture. In an even further aspect, the cement mixture comprises cement in an amount ranging from 19.8 wt % to 20.2 wt %, based on the total weight of the cement mixture.

In various aspects, the cement mixture comprises cement in an amount of at least about 12.0 wt %, 12.1 wt %, 12.2 wt %, 12.3 wt %, 12.4 wt %, 12.5 wt %, 12.6 wt %, 12.7 wt %, 12.8 wt %, or 12.9 wt %, based on the total weight of the cement mixture. In a further aspect, the cement mixture comprises cement in an amount of at least about 13.0 wt %, 13.1 wt %, 13.2 wt %, 13.3 wt %, 13.4 wt %, 13.5 wt %, 13.6 wt %, 13.7 wt %, 13.8 wt %, or 13.9 wt %, based on the total weight of the cement mixture. In a still further aspect, the cement mixture comprises cement in an amount of at least about 14.0 wt %, 14.1 wt %, 14.2 wt %, 14.3 wt %, 14.4 wt %, 14.5 wt %, 14.6 wt %, 14.7 wt %, 14.8 wt %, or 14.9 wt %, based on the total weight of the cement mixture. In a yet further aspect, the cement mixture comprises cement in an amount of at least about 15.0 wt %, 15.1 wt %, 15.2 wt %, 15.3 wt %, 15.4 wt %, 15.5 wt %, 15.6 wt %, 15.7 wt %, 15.8 wt %, or 15.9 wt %, based on the total weight of the cement mixture. In an even further aspect, the cement mixture comprises cement in an amount of at least about 16.0 wt %, 16.1 wt %, 16.2 wt %, 16.3 wt %, 16.4 wt %, 16.5 wt %, 16.6 wt %, 16.7 wt %, 16.8 wt %, or 16.9 wt %, based on the total weight of the cement mixture. In a still further aspect, the cement mixture comprises cement in an amount of at least about 17.0 wt %, 17.1 wt %, 17.2 wt %, 17.3 wt %, 17.4 wt %, 17.5 wt %, 17.6 wt %, 17.7 wt %, 17.8 wt %, or 17.9 wt %, based on the total weight of the cement mixture. In a yet further aspect, the cement mixture comprises cement in an amount of at least about 18.0 wt %, 18.1 wt %, 18.2 wt %, 18.3 wt %, 18.4 wt %, 18.5 wt %, 18.6 wt %, 18.7 wt %, 18.8 wt %, or 18.9 wt %, based on the total weight of the cement mixture. In an even further aspect, the cement mixture comprises cement in an amount of at least about 19.0 wt %, 19.1 wt %, 19.2 wt %, 19.3 wt %, 19.4 wt %, 19.5 wt %, 19.6 wt %, 19.7 wt %, 19.8 wt %, or 19.9 wt %, based on the total weight of the cement mixture. In a still further aspect, the cement mixture comprises cement in an amount of at least about 20.0 wt %, 20.1 wt %, 20.2 wt %, 20.3 wt %, 20.4 wt %, 20.5 wt %, 20.6 wt %, 20.7 wt %, 20.8 wt %, 20.9 wt %, or 21.0 wt %, based on the total weight of the cement mixture.

Typically, any cement can be used. In one aspect, the cement comprises hydraulic cement. In a further aspect, the cement comprises Portland cement, for example, Ordinary Portland Cement (OPC) Type I, Type IA, Type II, Type IIA, Type III, Type IIIA, Type IV, or Type V, or a combination thereof. In a yet further aspect, the non-hydraulic cement is a pozzolan-lime cement, slag-lime cement, supersulfated cement, calcium sulfoaluminate cement, natural cement, or geopolymer cement.

In a further aspect, the cement is a blended hydraulic cement comprising a Portland cement. In a still further aspect, the blended hydraulic cement is a Type IP, Type IS, or Type IT(AX)(BY) blended hydraulic cement. In an even further aspect, the cement comprises masonry cement, for example, a mortar or the like. In a still further aspect, the cement is in the dry form. If needed to set, water is typically added after the cement is mixed with the other components, for example, to form a cement-water slurry, and it is then ready to be applied. In a further aspect, the water and one or more components are mixed with the cement simultaneously

In various aspects, the coated iron oxide pellets of the present invention can be manufactured by various methods. Thus, in aspects of the invention, applying the cement mixture to iron oxide pellet can involve mixing uncoated iron oxide pellets, the cement mixture of the present invention, and optional additional components using conventional methods such as with an intensive mixer, such as a R02 Eirich mixer or any other mixing equipment.

Alternatively, because of the availability of spraying equipment in commercial processing facilities, applying the cement mixture to iron oxide pellet can involve various spraying methods to apply the cement mixture to the iron oxide pellets. In various further aspects, the equipment used in such processing methods includes, but is not limited to, the following: shower spray and various other types of equipment.

In various aspects, the drying step, i.e., step (c) in the foregoing, removes at least substantially all of the water initially present in the cement mixture applied to the iron oxide pellet. In a further aspect, the drying step removes about 100%, about 95%, about 90%, about 85%, about 80%, about 75%, about 70%, about 65%, about 60%, about 55%, about 50%, about 45%, about 40%, about 30%, about 20%, or about 10% of the water present in the initial cement mixture applied to the iron oxide pellet. In a further aspect, the drying step removes about 100%, about 99%, about 98%, about 97%, about 96%, about 95%, about 94%, about 93%, about 92%, about 91%, about 90%, about 89%, about 88%, about 87%, about 86%, about 85%, about 84%, about 83%, about 82%, about 81%, or about 80% of the water present in the initial cement mixture applied to the iron oxide pellet. The amount of water removed in the drying step can be controlled by both the temperature and the length of the drying step. In various aspects, it can be desirable during the drying step to remove essentially all of the water present in the initial cement mixture applied to the iron oxide pellet. Alternatively, in various aspects, it can be desirable during the drying step to allow a residual amount of the water present in the initial cement mixture applied to the iron oxide pellet to remain in the coating.

In various aspects, the iron coated pellet is air dried during the transit on a conveyor belt following application by spraying to the DRI furnace charging point. Alternatively, in a further aspect, the iron composite pellet can be dried using conventional methods, such as, for example, in the sun for a period of 1 hour to about 4 days or heating in a drying oven.

### D. METHODS OF USING THE COATED IRON OXIDE PELLETS

Also disclosed herein are methods of using the coated iron oxide pellets described herein above where decreased adherence of iron oxide pellet is needed. In various aspects, the coated iron oxide pellet of the present invention can be used to produce iron by various methods. In one aspect, the coated iron oxide pellet of the present invention can in the production of direct reduced iron (DRI). For example, the coated iron oxide pellet can be used in DRI production using conventional methods such as, in the presence of a reducing agent in a furnace, for example, a MIDREX furnace, or HYL III furnace, or any other DRI production equipment.

Direct reduction (“DR”) of iron, e.g. iron oxide or iron ore, generates metallic iron in solid form, also referred to as direct reduced iron (“DRI”), by removing oxygen using a reducing gas comprising hydrogen and carbon monoxide. In some cases, the reducing gas can be provided from the synthesis gas obtained from natural gas by steam methane reforming. Alternatively, the reducing gas can be produced in situ in the reducing reactor from supplied natural gas and oxygen. The reducing process can be illustrated by the following chemical reaction, where water and carbon dioxide are obtained as reaction byproducts:

Fe₂O₃+H₂→2Fe+3H₂O

Fe₂O₃+CO→2Fe+CO₂

Iron obtained from a DR process can be cooled and carbonized, e.g. by counterflowing gases in the lower portion of a direct reduction reactor according to the following reaction:

3Fe+CO+H₂→Fe₃C+H₂O

3Fe+CH₄→Fe₃C+2H₂

3Fe+2CO→Fe₃C+CO₂

By the foregoing chemical processes, products such as cold direct reduction iron, hot briquetted iron, and hot direct reduction iron can be manufactured.

In addition to the chemical reactions described herein above, methane reforming and water gas shift reactions can also occur in the gas phase based on the composition of the input reduction gas and operating temperatures in the reduction reaction vessel. These additional gas phase reactions include the following:

CH₄+2H₂O→CO₂+4H₂

CO₂+H₂→CO+H₂O

Thus, the gas exiting a direct reduction reactor, i.e. off-gas or top gas, comprises both unreacted gases present in the input reducing gas mixture and the gaseous reaction products illustrated in the reactions above. In addition, the input reducing gas mixture can comprise additional components such nitrogen. The top gas is a complex gaseous mixture comprising nitrogen, methane, water vapor, hydrogen, carbon dioxide, and carbon monoxide. In various DR processes, the top gas can be cleaned by scrubbing and carbon dioxide removed. For example, the top gas, following scrubbing and carbon dioxide removal, can be recycled back into the reducing gas stream and utilized for further direct reduction of iron.

In various aspects, the direct reduction process comprises a first module for reducing iron oxide comprising a first reducing gas inlet, a first reducing reactor, and a top gas outlet; wherein the first module, during operation, produces metallic iron and expels a top gas via the top gas outlet. An example of the first module for reducing iron by a direct reduction process is a production module or plant commonly using the Midrex® direct reduction process. In a further aspect, the first module for reducing iron oxide by direct reduction process utilizes a Midrex® direct reduction process and comprises a first reducing gas inlet, a first reducing reactor, and a top gas outlet, wherein the first module, during operation, produces metallic iron and expels a top gas via the top gas outlet.

In various aspects, the first module direct reduction process can be characterized by use of a low pressure reducing gas introduced to a moving bed shaft reactor where the reducing gas moves counter-current to the lump iron oxide (or alternatively, lump iron oxide pellets). In this case, the reducing gas (from about 10 mol % to about 20 mol % CO; and from about 80 mol % to about 90 mol % H₂) of the first module direct reduction process is typically produced from natural gas using a CO₂ reforming process in combination with a catalyst, e.g. Midrex reforming process with the Midrex proprietary catalyst. The first module direct reduction process is further characterized by a single reformer rather than a reformer / heater combination and by lack of a requirement to cool the reducing gas prior to introduction to the shaft reactor.

In various aspects, the first reducing reactor is a moving bed shaft reactor. Appropriate reactor designs are commercially available from Midrex Technologies, Inc. (Charlotte, N.C., US). In a further aspect, the first reducing reactor comprises a vertical cylindrical vessel containing an internal refractory insulation, wherein the iron oxide flows down by gravity and is contacted by an upward flowing reducing gas. In a still further aspect, the iron oxide is present as iron oxide pellets or lump iron ore.

In a further aspect, the first reducing gas inlet introduces to the first reducing reactor a reducing gas at a pressure from about 1 bar to about 1.5 bar at a temperature from about 800° C. to about 850° C. The reducing gas can generally be formed natural gas or other gaseous stream that can be reformed or cracked to produce H₂ or CO to be used in the reduction of the iron oxide. In general, high methane containing natural gas is the most common form of input gas for the formation of the reducing gas. The input gas may be a byproduct of other processes. In a still further aspect, the reducing gas mixture is formed from natural gas and water. In a yet further aspect, the reducing gas mixture comprises carbon monoxide and hydrogen.

Alternatively, the direct reduction process comprises a first module for reducing iron oxide comprising a first reducing gas inlet, a reducing reactor, a reducing gas heater, and a steam boiler; wherein the first module, during operation, produces metallic iron; and wherein the reducing reactor, during operation, produces metallic iron and operates at a pressure of at least about 5 bar. An example of the alternative first module for reducing iron by a direct reduction process is a production module or plant commonly using the HYL® direct reduction process. In a further aspect, the first module for reducing iron oxide by direct reduction process utilizes a HYL® direct reduction process comprising a reducing gas inlet, a reducing reactor, a reducing gas heater, and a steam boiler, wherein the reducing reactor, during operation, produces metallic iron; and wherein the second module, during operation, produces metallic iron and operates at a pressure of at least about 5 bar.

The alternative first module direct reduction process is characterized by use of a high pressure reducing gas introduced to a moving bed shaft reactor where the reducing gas moves counter-current to the lump iron oxide (or alternatively, lump iron oxide pellets). In this case, the reducing gas is generated by self-reforming in the second reduction reactor, with make-up gas—typically natural gas—being provided to the reducing gas circuit and injecting oxygen at the inlet of the second reducing reactor. The HYL®-type direct reduction process is further characterized by a reducing gas heater. The HYL®-type direct reduction process can optionally comprise a steam methane reforming unit.

In various aspects, the reducing reactor is a moving bed shaft reactor. Appropriate reactor designs are commercially available from Tenova HYL (Coraopolis, Pa., US). In a further aspect, the reducing reactor comprises a vertical cylindrical vesse, wherein iron oxide is introduced to the second reducing reactor via a sealing mechanism that is based upon a pressure lock system. In a still further aspect, once the iron oxide is introduced in the second reducing reactor, it flows down by gravity and is contacted by an upward flowing reducing gas. In a still further aspect, the iron oxide is present as iron oxide pellets, lump iron ore, or mixture thereof.

It is understood in the foregoing discussion that reference to iron oxide comprises the coated iron oxide pellets of the present invention. Moreover, the coated iron oxide pellets of the present invention can be utilized in other direct reduction processes as known to one skilled in the art.

In use, the coated iron oxide pellets are used in a direct reduction iron process. Thus, in an exemplary aspect, disclosed is a process comprising: a) providing a cement mixture; b) applying the cement mixture to iron oxide pellets to provide a coated iron oxide pellet; c) introducing the coated iron oxide pellet to a vertical furnace; and d) reducing the coated iron oxide pellet. It is understood that the cement mixture applied to the iron oxide pellet is as described herein above.

In various aspects, the coated iron oxide pellet has an improved sticking index, i.e., a sticking index less than that of an iron oxide pellet lacking the cement coating of the present invention. In a further aspect, the sticking index of the coated iron oxide pellet is less than or equal to about 10%, is less than or equal to about 9%, is less than or equal to about 8%, is less than or equal to about 7%, is less than or equal to about 6%, is less than or equal to about 5%, is less than or equal to about 4%, is less than or equal to about 3%, is less than or equal to about 2%, or is less than or equal to about 1%.

In various aspects, the coated iron oxide pellet is highly metallized following reduction in the vertical furnace. In still further aspect, the metallization of the iron oxide pellet after reduction in the vertical furnace is at least about 90%, is at least about 91%, is at least about 92%, is at least about 93%, is at least about 94%, is at least about 95%, is at least about 96%, is at least about 97%, is at least about 98%, or is at least about 99%.

In one aspect, the invention provides an iron oxide-reducing system comprising: a) a module for reducing iron oxide by direct reduction process, the module comprising a reducing gas inlet, a reducing reactor, and a top gas outlet; b) providing the disclosed coated iron oxide pellet to the reducing reactor; c) carrying out direct reduction of the coated iron oxide pellet; and d) expel the reduced iron from the reducing reactor.

Optionally, in various aspects, the disclosed system, apparatus, and methods can be operated or performed on an industrial scale. In one aspect, the system, apparatus, and methods disclosed herein can be configured to produce the coated iron oxide pellets with decreased adherance of the invention on an industrial scale. For example, according to further aspects, the apparatus and methods can produce batches of coated iron oxide pellets with decreased adherence on an industrial scale. In a further aspect, the batch size can comprise any desired industrial-scale batch size. In a still further aspect, the batch size can optionally be at least about 50 lbs, including exemplary batch sizes of at least about 100 lbs, at least about 200 lbs, at least about 250 lbs, at least about 300 lbs, at least about 350 lbs, at least about 400 lbs, at least about 450 lbs, at least about 500 lbs, at least about 600 lbs, at least about 700 lbs, at least about 800 lbs, at least about 900 lbs, at least about 1000 lbs, or greater. In a yet further aspect, the batch size can optionally be at least about 1 ton, including exemplary batch sizes of at least about 10 tons, at least about 25 tons, at least about 50 tons, at least about 100 tons, at least about 250 tons, at least about 500 tons, at least about 750 tons, at least about 1000 tons, at least about 2,500 tons, or greater. In an additional aspect, the batch size can optionally range from about 1 ton to about 2,500 tons, such as, for example, from about 10 tons to about 1,000 tons, from about 1,000 tons to about 2,500 tons, from about 100 tons to about 500 tons, from about 500 tons to about 1,000 tons, from about 10 tons to about 100 tons, from about 100 tons to about 250 tons, from about 500 tons to about 750 tons, or from about 750 tons to about 1,000 tons.

In various aspects, the disclosed system, apparatus, and methods can be operated or performed on any desired time scale or production schedule that is commercially practicable. In various aspects, the disclosed system, apparatus, and methods can produce a quantity of at least 50 lbs of coated iron oxide pellets with decreased adherance in a period of 1 day or less, including exemplary quantities of at least about 100 lbs, at least about 200 lbs, at least about 250 lbs, at least about 300 lbs, at least about 350 lbs, at least about 400 lbs, at least about 450 lbs, at least about 500 lbs, at least about 600 lbs, at least about 700 lbs, at least about 800 lbs, at least about 900 lbs, and at least about 1000 lbs. In various further aspects, the disclosed system, apparatus, and methods can produce a quantity of at least 1 ton of coated iron oxide pellets with decreased adherance in a period of about 1 day or less, including exemplary quantities of at least about 10 tons, 100 tons, 500 tons, or 1000 tons, or greater within the period. In a further aspect, the period of time can be about 2 days, 3 days, 4 days, 5 days or less, 6 days, 7 days, or greater. In a still further aspect, the period of time can be 4 hours, including exemplary times of 8 hours, 12 hours, 18 hours, 24 hours, 36 hours, 48 hours, 60 hours, or greater. In a still further aspect, the quantity of coated iron oxide pellets produced can range from about 1 ton to about 100 tons, and the period of time can range from about 1 hour to about 1 day, for example, 100-1000 tons in a period of 1 to 24 hours. In a yet further aspect, the quantity of coated iron oxide pellets produced can range from about 100 lbs to about 1000 lbs, and the period of time can range from about 1 hour to about 1 day, for example, 100-1000 lbs in a period of 1 to 24 hours.

In additional aspects, the components of the disclosed system and apparatus can be shaped and sized to permit production of coated iron oxide pellets on an industrial scale. Similarly, it is contemplated that the components of the disclosed system and apparatus can comprise materials having material properties that are configured to permit production of coated iron oxide pellets with decreased adherence on an industrial scale. In further aspects, the components of the disclosed system and apparatus can be shaped and sized to produce coated iron oxide pellets with decreased adherance in accordance with the desired time scale or production schedule. Similarly, it is contemplated that the components of the disclosed system and apparatus can comprise materials having material properties that are configured to permit production of coated iron oxide pellets with decreased adherence in accordance with the desired time scale or production schedule.

### E. ASPECTS

In various aspects, the present invention pertains to and includes at least the following aspects.

Aspect 1: A direct reduction process using a vertical furnace, the process comprising:
(a) providing a cement mixture comprising from about 12 wt % to about 20 wt % cement;
(b) applying the cement mixture to iron oxide pellets to provide a coated iron oxide pellet;
(c) introducing the coated iron oxide pellet to a vertical furnace; and
(d) reducing the coated iron oxide pellet;
   wherein the sticking index of the coated iron oxide pellet is less than or equal to about 5%; and
   wherein the metallization of the iron oxide pellet after reduction in the vertical furnace is at least about 92%.

Aspect 2: The process of aspect 1, wherein the cement mixture is applied in a ratio of about 0.4 to about 1.0 kg cement/ton iron oxide pellets.

Aspect 3: The process of aspect 2, wherein the cement mixture is applied in a ratio of about 0.4 to about 0.6 kg cement/ton iron oxide pellets.

Aspect 4: The process of aspect 2 or 3, wherein the cement mixture is applied in a ratio of about 0.5 kg cement/ton iron oxide pellets.

Aspect 5: The process of any of aspects 1-4, wherein the cement mixture comprises a hydraulic cement.

Aspect 6: The process of aspect 5, wherein the cement is a hydraulic cement.

Aspect 7: The process of aspect 6, wherein the hydraulic cement is a Portland Cement.

Aspect 8: The process of aspect 7, wherein the Portland Cement is per ASTM C-150 a Type I, Type IA, Type II, Type IIA, Type III, Type IIIA, Type IV, or Type V Portland Cement.

Aspect 9: The process of aspect 5, wherein the hydraulic cement is a blended hydraulic cement.

Aspect 10: The process of aspect 9, wherein the blended hydraulic cement is a Type IP, Type IS, or Type IT(AX)(BY) blended hydraulic cement.

Aspect 11: The process of any of aspects 1-8, further comprising reduction in the vertical furnace at a temperature of about 995° C.

Aspect 12: The process of any of aspects 1-11, wherein the cement mixture comprises about 20 wt % cement.

Aspect 13: The process of any of aspects 1-12, wherein applying the cement mixture is spraying the cement mixture directly onto the iron oxide pellets.

Aspect 14: A composition to decrease sticking of direct reduction iron oxide pellets, the composition comprising an iron oxide pellet and a cement mixture comprising from about 12 wt % to about 20 wt % cement.

Without further elaboration, it is believed that one skilled in the art can, using the description herein, utilize the present invention. The following examples are included to provide addition guidance to those skilled in the art of practicing the claimed invention. The examples provided are merely representative of the work and contribute to the teaching of the present invention. Accordingly, these examples are not intended to limit the invention in any manner.

While aspects of the present invention can be described and claimed in a particular statutory class, such as the system statutory class, this is for convenience only and one of skill in the art will understand that each aspect of the present invention can be described and claimed in any statutory class. Unless otherwise expressly stated, it is in no way intended that any method or aspect set forth herein be construed as requiring that its steps be performed in a specific order. Accordingly, where a method claim does not specifically state in the claims or descriptions that the steps are to be limited to a specific order, it is no way intended that an order be inferred, in any respect. This holds for any possible non-express basis for interpretation, including matters of logic with respect to arrangement of steps or operational flow, plain meaning derived from grammatical organization or punctuation, or the number or type of aspects described in the specification.

Throughout this application, various publications are referenced. The disclosures of these publications in their entireties are hereby incorporated by reference into this application in order to more fully describe the state of the art to which this pertains. The references disclosed are also individually and specifically incorporated by reference herein for the material contained in them that is discussed in the sentence in which the reference is relied upon. Nothing herein is to be construed as an admission that the present invention is not entitled to antedate such publication by virtue of prior invention. Further, the dates of publication provided herein can be different from the actual publication dates, which can require independent confirmation.

### F. EXAMPLES

The following examples are put forth so as to provide those of ordinary skill in the art with a complete disclosure and description of how the compounds, compositions, articles, devices and/or methods claimed herein are made and evaluated, and are intended to be purely exemplary and are not intended to limit the disclosure. Efforts have been made to ensure accuracy with respect to numbers (e.g., amounts, temperature, etc.), but some errors and deviations should be accounted for. Unless indicated otherwise, parts are parts by weight, temperature is in ° C. or is at ambient temperature, and pressure is at or near atmospheric. Unless indicated otherwise, percentages referring to composition are in terms of wt %.

There are numerous variations and combinations of reaction conditions, e.g., component concentrations, desired solvents, solvent mixtures, temperatures, pressures and other reaction ranges and conditions that can be used to optimize the product purity and yield obtained from the described process. Only routine experimentation, if any, will be required to optimize such process conditions. Several methods for preparing the compounds of this invention are illustrated in the following prophetic examples.

### Example 1

In one aspect, Table 1 below shows the typical analysis of iron ore or oxide fines that can comprise the coated iron oxide pellets. In further aspects, other ingredients can include various amounts of carbon, sulfur, sodium, potassium, zinc, chlorine, fluorine, and/or water.

TABLE 1*

| Element | Iron oxide pellet |
|---|---|
| Fe-Tot | 65.7 |
| Fe₂O₃ | 96.6 |
| MgO | 0.8 |
| Al₂O₃ | 0.3 |
| SiO₂ | 0.8 |
| P₂O₅ | 0.2 |
| SO₃ | 0.0 |
| CaO | 0.6 |
| TiO₂ | 0.0 |
| V₂O₅ | 0.0 |
| MnO | 0.6 |
| ZnO | 0.0 |
| PbO | 0.0 |
| Others | 0.0 |
| Total | 100.0 |

*Amounts provided in terms of percent of total composition (by weight).

In one aspect, the outer coating can be prepared by pre-blending all outer coating constituents comprising cement in a dry-blend and mixed for a desired duration. The outer coating pre-blend is then mixed with water to form a cement-water slurry comprising from about 12 wt % to abour 20 wt % cement. The cement-water slurry can then be applied directly to the iron oxide pellets using a coating device, e.g. a sprayer, and dried, e.g. at a suitable temperature for a suitable duration. In some aspects, coated iron oxide pellets can be air dried at ambient temperature, e.g. about 15° C. to about 45° C. In other aspects, coated iron oxide pellets can be heat dried. In various aspects, the final coated iron oxide pellets can comprise cement in a ratio of from about 0.5 kg to about 1.0 kg cement/ton iron oxide pellets.

In a further aspect, the outer coating can be prepared by pre-blending all outer coating constituents comprising cement in a dry-blend and mixed for a desired duration. The outer coating pre-blend can then mixed with water to form a cement-water slurry comprising from about 12 wt % to abour 20 wt % cement. The cement-water slurry can then be applied directly to the iron oxide pellets using a coating device, e.g. a sprayer, and dried, e.g. at a suitable temperature for a suitable duration. In some aspects, coated iron oxide pellets can be air dried at ambient temperature, e.g. about 15° C. to about 50° C. In other aspects, coated iron oxide pellets can be heat dried. In various aspects, the final coated iron oxide pellets can comprise cement in a ratio of from about 0.5 kg to about 1.0 kg cement/ton iron oxide pellets.

In one aspect, the outer coating can be prepared by pre-blending all outer coating constituents comprising cement in a dry-blend and mixed for a desired duration. The outer coating pre-blend can then be mixed with water to form a cement-water slurry comprising from about 20 wt % cement and the balance of the wt % can be water. The cement-water slurry can then be applied directly to the iron oxide pellets using a sprayer, and air-dried at about 15° C. to about 45° C. In other aspects, coated iron oxide pellets can be heat dried. In various aspects, the final coated iron oxide pellets can comprise cement in a ratio of about 0.5 kg cement/ton iron oxide pellets.

### Determining Sticking Index (SI)

In one aspect, the present methods can provide coated iron oxide pellets having reduced adherence. In one aspect, the sticking index of the coated iron oxide pellets can be determined by dropping the clustered pellets consisting of at least two pellets from a height of 1 m against a hard surface multiple times. In a further aspect, the clusters remaining after each drop are then calculated, and the results expressed as a percentage of clusters remaining after each drop. After all drops are performed, the number of drops versus percentage of clusters is plotted using methods known to those of skill in the art. In a still further aspect, the sticking index (SI) can then be calculated using the area under the curve. In one aspect, SI is zero when no clusters of at least two pellets form, and SI is 100 when all pellets are clustered and do not disaggregate during dropping.

### Determining Metallization

In one aspect, the present methods can provide coated iron oxide pellets having improved metallization. In one aspect, the metallization of the coated iron oxide pellets can be determined by testing the coated iron oxide pellet after isothermal reduction of the coated iron oxide pellet on a fixed bed at 995° C., using reducing gases consisting of 40% CO and 60% H₂.

The patentable scope of the invention is defined by the claims, and can include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. A direct reduction process using a vertical furnace, the process comprising:
(a) providing a cement mixture comprising from about 12 wt % to about 20 wt % cement;
(b) applying the cement mixture to iron oxide pellets to provide a coated iron oxide pellet;
(c) introducing the coated iron oxide pellet to a vertical furnace; and
(d) reducing the coated iron oxide pellet;
wherein the sticking index of the coated iron oxide pellet is less than or equal to about 5%; and
wherein the metallization of the iron oxide pellet after reduction in the vertical furnace is at least about 92%.

2. The process of claim 1, wherein the cement mixture is applied in a ratio of about 0.4 to about 1.0 kg cement/ton iron oxide pellets.

3. The process of claim 2, wherein the cement mixture is applied in a ratio of about 0.4 to about 0.6 kg cement/ton iron oxide pellets.

4. The process of claim 2, wherein the cement mixture is applied in a ratio of about 0.5 kg cement/ton iron oxide pellets.

5. The process of claim 1, wherein the cement mixture comprises a hydraulic cement.

6. The process of claim 5, wherein the cement is a hydraulic cement.

7. The process of claim 6, wherein the hydraulic cement is a Portland Cement.

8. The process of claim 7, wherein the Portland Cement is per ASTM C-150 a Type I, Type IA, Type II, Type IIA, Type III, Type IIIA, Type IV, or Type V Portland Cement.

9. The process of claim 5, wherein the hydraulic cement is a blended hydraulic cement.

10. The process of claim 9, wherein the blended hydraulic cement is a Type IP, Type IS, or Type IT(AX)(BY) blended hydraulic cement.

11. The process of claim 1, further comprising reduction in the vertical furnace at a temperature of about 995° C.

12. The process of claim 1, wherein the cement mixture comprises about 20 wt % cement.

13. The process of claim 1, wherein applying the cement mixture is spraying the cement mixture directly onto the iron oxide pellets.

14. A composition to decrease sticking of direct reduction iron oxide pellets, the composition comprising an iron oxide pellet and a cement mixture comprising from about 12 wt % to about 20 wt % cement.
